(19) United States
(12) Patent Application Publication
(10) Pub. No.: US 2024/0163994 A1
(43) Pub. Date: May 16, 2024

(54) LAMP BEAD STRUCTURE ENCAPSULATING LED DRIVER ICS CONNECTED IN PARALLEL

(71) Applicant: Bo Guan, Shenzhen (CN)

(72) Inventor: Bo Guan, Shenzhen (CN)

(21) Appl. No.: 18/418,478

(22) Filed: Jan. 22, 2024

(51) Int. Cl. H05B 45/52; H05B 45/44

(52) U.S. Cl. CPC H05B 45/52; H05B 45/44

(57) ABSTRACT

Disclosed is a lamp bead structure encapsulating LED driver ICs connected in parallel, comprising a power supply, a controller and a lamp bead group, where the power supply supplies power to the controller and the lamp bead group, the lamp bead group includes a plurality of LED lamps, the LED lamps are each provided with a DIN, a VDD pin and a VSS pin, the DIN pins of all the LED lamps are electrically connected to the controller, and are connected in parallel with one another; the VDD pins of all the LED lamps are electrically connected to a positive electrode of the power supply, and are connected in parallel with one another; and the VSS pins of all the LED lamps are electrically connected to a negative electrode of the power supply, and are connected in parallel with one another.

### TECHNICAL FIELD

The present disclosure relates to the technical field of light-emitting diode (LED) driving and packaging, and in particular to a lamp bead structure encapsulating LED driver ICs connected in parallel.

### BACKGROUND

LED light products, such as LED light strips and LED light strings, are integrated with a plurality of LED lamps. These LED lamps are electrically connected with one another in series. Thus, when one of the LED lamps is damaged, the entire LED light product will not light up, which has always been a pain point for the LED light product. In addition, for the traditional packaging structure of an LED light, each LED lamp thereof has four pins, that is, a DIN pin, a DOUT pin, a VDD pin and a VSS pin. When all LED lamps thereof are connected in series, signal data of the LED light needs to be transmitted from one LED lamp to the next LED lamp, so that almost all of the LED lamps are in a working state, resulting in a high power consumption of the LED light all the times, which will shorten the service life of the LED lamps, and the overall service life of the LED light products is also shortened.

### SUMMARY

An objective of the present disclosure is to provide a lamp bead structure encapsulating LED driver ICs connected in parallel, aiming to solve the problems in the traditional packaging structure of LED lights that when one of the LED lamps thereof is damaged, the entire LED light product will not light up, and that almost all of the LED lamps thereof are in a working state, which will shorten the service life of the LED light products.

According to a first aspect of the present disclosure, a lamp bead structure encapsulating LED driver ICs connected in parallel is provided, the structure includes a power supply, a controller and a lamp bead group, where the power supply supplies power to the controller and the lamp bead group, the lamp bead group includes a plurality of LED lamps, the LED lamps are each provided with a DIN, a VDD pin and a VSS pin, the DIN pins of all the LED lamps are electrically connected to the controller, and the DIN pins of all the LED lamps are connected in parallel with one another; the VDD pins of all the LED lamps are electrically connected to a positive electrode of the power supply, and the VDD pins of all the LED lamps are connected in parallel with one another; and the VSS pins of all the LED lamps are electrically connected to a negative electrode of the power supply, and the VSS pins of all the LED lamps are connected in parallel with one another.

Further, each LED lamp is provided with a control IC chip and a plurality of monochromatic light-emitting units, serial codes or ID addresses of the control IC chips of all the LED lamps are different, the control IC chip is electrically connected to the controller through the DIN pin, and the control IC chip is further electrically connected to the positive and negative electrodes of the power supply through the VDD and VSS pins, respectively.

Further, the plurality of monochromatic light-emitting units are an R light-emitting unit, a G light-emitting unit and a B light-emitting unit, respectively, and the plurality of monochromatic light-emitting units are all electrically connected to the VDD pins.

Further, the controller uses an MCU chip.

According to a second aspect of the present disclosure, a light string that uses the above lamp bead structure encapsulating LED driver ICs connected in parallel is provided.

According to a third aspect of the present disclosure, a light strip that uses the above lamp bead structure encapsulating LED driver ICs connected in parallel is provided.

According to a fourth aspect of the present disclosure, an advertising light box that uses the above lamp bead structure encapsulating LED driver ICs connected in parallel is provided.

According to a fifth aspect of the present disclosure, an advertising screen that uses the above lamp bead structure encapsulating LED driver ICs connected in parallel is provided.

Compared with the prior art, the present disclosure has the following beneficial effects:

The present disclosure achieves parallel control of all the LED lamps in the lamp bead group, such that even if one or a group of LED lamps are damaged, the others can still work normally, thereby being highly economical.

By eliminating the DOUT serial connection pin in the traditional packaging structure of LED lights, the present disclosure reduces heat generated by a load of the LED lamps connected in series, which is beneficial to extending the service life of the LED lamps, and the service life of the LED light products is accordingly extended.

Since the present disclosure eliminates the DOUT serial connection pin, sizes of the VDD, VSS and DIN pins can be increased accordingly, making the welding more robust and the operation more stable, and the resistance value can be lowered.

Since the present disclosure eliminates the DOUT pin and all new LED lamps are packaged, it is possible to produce the LED lamps with the smallest possible size, and a screen or wiring a final product can be optimized, simplifying the circuit design.

The present disclosure transmits signals directly through the MCU chip, achieving point-to-point transmission with a faster transmission rate.

By adopting a separate DIN pin and a matchable controller, the present disclosure can be adapted to many different application scenarios, such as light strings, LED strips, advertising light boxes, or display screens, and can also display different patterns or color controls, making it very practical.

### BRIEF DESCRIPTION OF THE DRAWINGS

FIG. 1 is a block diagram of an electrical control structure of a lamp bead structure encapsulating parallel LED driver IC in the present disclosure.

FIG. 2 is a block diagram of an electrical control structure that all LED lamps are connected to a power supply and a controller of a lamp bead structure encapsulating parallel LED driver IC in the present disclosure.

FIG. 3 is a block diagram of an internal electrical control structure of an LED lamp of a lamp bead structure encapsulating parallel LED driver IC in the present disclosure.

FIG. 4 is a diagram of one use example of a light string or a light strip.

FIG. 5 is a diagram of another use example of a light string or a light strip.

FIG. 6 is a diagram of one use example of an advertising light box or an advertising screen.

In the accompanying drawings: 1. power supply; 2. controller; 3. lamp bead group; 31. LED lamp; 311. control IC chip; and 312. monochromatic light-emitting unit.

### DETAILED DESCRIPTIONS OF THE EMBODIMENTS

In the present disclosure, unless otherwise explicitly specified and defined, the terms “mounting”, “connecting”, “connection”, “fixing”, etc. should be understood in a broad sense, for example, they may be a fixed connection, a detachable connection, or an integrated connection; may be a mechanical connection, or an electrical connection; may be a direct connection, or an indirect connection via an intermediate medium; and may be communication inside two elements, or an interactive relation between two elements. Those of ordinarily skilled in the art can understand specific meanings of the above terms in the present disclosure according to specific circumstances.

The present disclosure will be further described below in conjunction with the accompanying drawings and specific embodiments:

### Embodiment 1

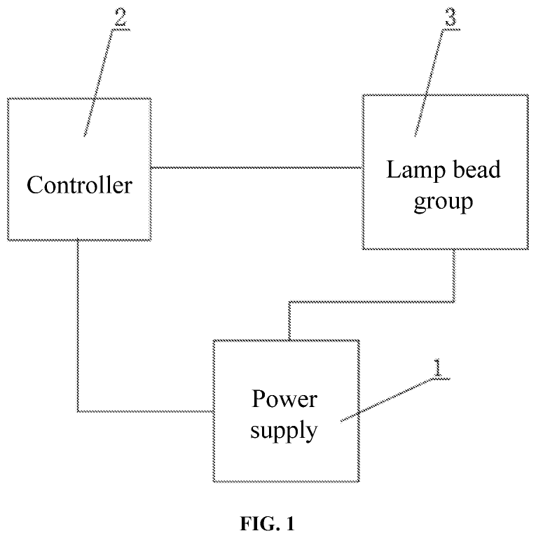

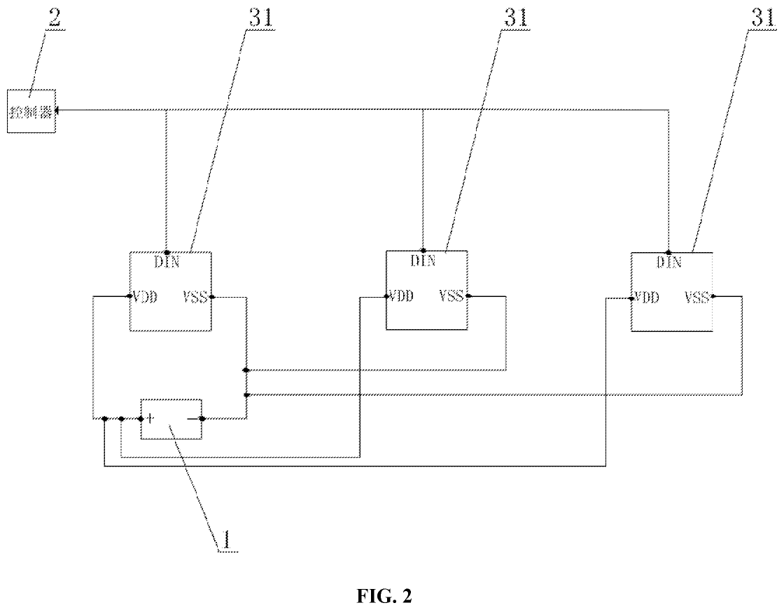

This embodiment provides a lamp bead structure encapsulating LED driver ICs connected in parallel, as shown in FIGS. 1-2, including a power supply 1, a controller 2, and a lamp bead group 3, where the power supply 1 supplies power to the controller 2 and the lamp bead group 3, the controller 2 uses an MCU chip, and the lamp bead group 3 includes a plurality of LED lamps 31. As shown in FIG. 2, the lamp bead group 3 includes a plurality of LED lamps 31, which is simply an example, and the lamp bead group 3 can also include two, four, five, or more LED lamps 31. The LED lamps 31 are each provided with a DIN, a VDD pin and a VSS pin, where the DIN pins of all the LED lamps 31 are electrically connected to the controller 2, and the DIN pins of all the LED lamps 31 are connected in parallel with one another. The VDD pins of all the LED lamps 31 are electrically connected to a positive electrode of the power supply 1, and the VDD pins of all the LED lamps 31 are connected in parallel with one another. The VSS pins of all the LED lamps 31 are electrically connected to a negative electrode of the power supply 1, and the VSS pins of all the LED lamps 31 are connected in parallel with one another.

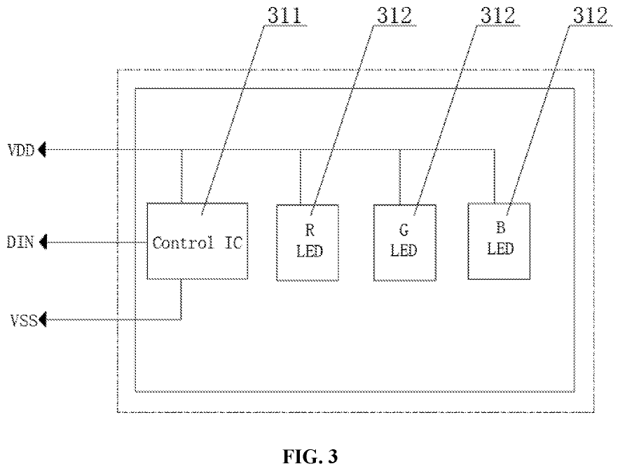

As shown in FIG. 3, each LED lamp 31 is provided with a control IC chip 311 and a plurality of monochromatic light-emitting units 312, where the plurality of monochromatic light-emitting units 312 are an R light-emitting unit, a G light-emitting unit and a B light-emitting unit, respectively, and the plurality of monochromatic light-emitting units 312 are all electrically connected to the VDD pins, and are further electrically connected to the positive electrode of the power supply 1 through the VDD pins. In one lamp bead group 3, serial codes or ID addresses of the control IC chips 311 of all the LED lamps 31 are different, for example, a first LED lamp 31 has a serial code or an ID address 001, a second LED lamp 31 has a serial code or an ID address 002, and so forth. The control IC chip 311 is electrically connected to the controller 2 through the DIN pin, and the control IC chip 311 is further electrically connected to the positive and negative electrodes of the power supply 1 through the VDD and VSS pins, respectively.

Working principle: The present disclosure achieves parallel control of all the LED lamps 31 in the lamp bead group 3, such that even if one or a group of LED lamps 31 are damaged, the others can still work normally, thereby being highly economical. By eliminating the DOUT serial connection pin in the traditional packaging structure of LED lights, the present disclosure makes signal data of each LED lamp 31 independent, with no need to be transmitted from one LED lamp 31 to the next LED lamp 31, such that when each LED lamp 31 is addressing, most of the LED lamps 31 are in a dormant state. However, for the traditional structure, all of the LED lamps 31 are almost always in a working state during transmission, leading to a relatively high power consumption of the LED lamps 31, close to 400 μA. The present disclosure allows the LED lamp 31 to operate in a state of less than 5 μA for most of the time, effectively reducing energy consumption. Therefore, the present disclosure reduces heat generated by a load of the LED lamps 31 connected in series, which is beneficial to extending the service life of the LED lamps 31, and the service life of the LED light products is accordingly extended. Since the present disclosure eliminates the DOUT serial connection pin, sizes of the VDD, VSS and DIN pins can be increased accordingly, making the welding more robust and the operation more stable, and the resistance value can be lowered. Since the present disclosure eliminates the DOUT pin and all new LED lamps 31 are packaged, it is possible to produce the LED lamps 31 with the smallest possible size, and a screen or wiring a final product can be optimized, simplifying the circuit design. In addition, the present disclosure transmits signals directly through the MCU chip, achieving point-to-point transmission with a faster transmission rate.

### Embodiment 2

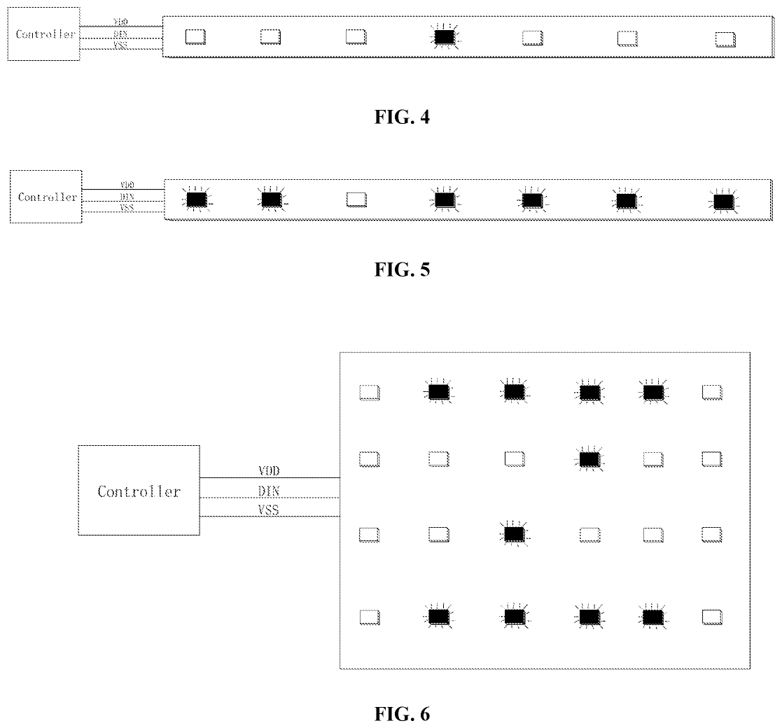

This embodiment provides a light string, as shown in FIG. 4 or FIG. 5, the light string uses the lamp bead structure encapsulating LED driver ICs connected in parallel provided in Embodiment 1. As can be seen from FIG. 1, the light string can selectively light up any one of the LED lamps 31. As can be seen from FIG. 2, even if any one of the LED lamps 31 is damaged, the other LED lamps 31 of the light string can still work normally.

### Embodiment 3

This embodiment provides a light strip, as shown in FIG. 4 or FIG. 5, the light strip uses the lamp bead structure encapsulating LED driver ICs connected in parallel provided in Embodiment 1. As can be seen from FIG. 1, the light strip can selectively light up any one of the LED lamps 31. As can be seen from FIG. 2, even if any one of the LED lamps 31 is damaged, the other LED lamps 31 of the light strip can still work normally.

### Embodiment 4

This embodiment provides an advertising light box, as shown in FIG. 6, the advertising light box uses the lamp bead structure encapsulating LED driver ICs connected in parallel provided in Embodiment 1. As can be seen from FIG. 6, the advertising light box can selectively control and light up any LED lamp 31, and through a reasonable program setting, the advertising light box can display a preset luminous shape or luminous pattern, such as a Z shape.

### Embodiment 5

This embodiment provides an advertising screen or a display screen, as shown in FIG. 6, the advertising screen uses the lamp bead structure encapsulating LED driver ICs connected in parallel provided in Embodiment 1. As can be seen from FIG. 6, the advertising light box can selectively control and light up any LED lamp 31, and through a reasonable program setting, the advertising light box can display a preset luminous shape or luminous pattern, such as a Z shape.

Therefore, by adopting a separate DIN pin and a matchable controller, it can adapt to many different application scenarios, such as light strings, LED strips, advertising light boxes, advertising screens, or display screens, and can also display different patterns or color controls, making it very practical.

The above descriptions are only preferred embodiments of the present disclosure, and are not intended to be limiting of the present disclosure, and various changes and modifications may be made by those skilled in the art. Any modifications, equivalent substitutions, improvements, and the like within the spirit and principles of the present disclosure are intended to be included within the scope of protection of the present disclosure.

What it claimed is:

1. A lamp bead structure encapsulating LED driver ICs connected in parallel, comprising a power supply (1), a controller (2) and a lamp bead group (3), wherein the power supply (1) supplies power to the controller (2) and the lamp bead group (3), the lamp bead group (3) comprises a plurality of LED lamps (31), the LED lamps (31) are each provided with a DIN, a VDD pin and a VSS pin, the DIN pins of all the LED lamps (31) are electrically connected to the controller (2), and the DIN pins of all the LED lamps (31) are connected in parallel with one another; the VDD pins of all the LED lamps (31) are electrically connected to a positive electrode of the power supply (1), and the VDD pins of all the LED lamps (31) are connected in parallel with one another; and the VSS pins of all the LED lamps (31) are electrically connected to a negative electrode of the power supply (1), and the VSS pins of all the LED lamps (31) are connected in parallel with one another.

2. The lamp bead structure encapsulating LED driver ICs connected in parallel according to claim 1, wherein each LED lamp (31) is provided with a control IC chip (311) and a plurality of monochromatic light-emitting units (312), serial codes or ID addresses of the control IC chips (311) of all the LED lamps (31) are different, the control IC chip (311) is electrically connected to the controller (2) through the DIN pin, and the control IC chip (311) is further electrically connected to the positive and negative electrodes of the power supply (1) through the VDD and VSS pins, respectively.

3. The lamp bead structure encapsulating LED driver ICs connected in parallel according to claim 2, wherein the plurality of monochromatic light-emitting units (312) are an R light-emitting unit, a G light-emitting unit and a B light-emitting unit, respectively, and the plurality of monochromatic light-emitting units (312) are all electrically connected to the VDD pins.

4. The lamp bead structure encapsulating LED driver ICs connected in parallel according to claim 1, wherein the controller (2) uses an MCU chip.

5. A light string, wherein the light string uses the lamp bead structure encapsulating LED driver ICs connected in parallel according to claim 1.

6. A light strip, wherein the light strip uses the lamp bead structure encapsulating LED driver ICs connected in parallel according to claim 1.

7. An advertising light box, wherein the advertising light box uses the lamp bead structure encapsulating LED driver ICs connected in parallel according to claim 1.

8. An advertising screen, wherein the advertising screen uses the lamp bead structure encapsulating LED driver ICs connected in parallel according to claim 1.
